(19) United States
(12) Patent Application Publication
(10) Pub. No.: US 2025/0044650 A1
(43) Pub. Date: Feb. 6, 2025

(54) DISPLAY PANEL AND MANUFACTURING METHOD THEREOF

(71) Applicant: HANNSTAR DISPLAY CORPORATION, Taipei City (TW)

(72) Inventors: Jhih-Jie Huang, Miaoli County (TW); I-Tung Chen, New Taipei City (TW)

(73) Assignee: HANNSTAR DISPLAY CORPORATION, Taipei City (TW)

(21) Appl. No.: 18/747,470

(22) Filed: Jun. 19, 2024

(30) Foreign Application Priority Data
Jul. 31, 2023 (TW) 112128546

(51) Int. Cl. G02F 1/1343; G02F 1/1335; G02F 1/167; G02F 1/1676

(52) U.S. Cl. CPC G02F 1/13439; G02F 1/133553; G02F 1/167; G02F 1/1676; G02F 2203/09

(57) ABSTRACT

A display panel includes a substrate and a plurality of pixel units. The pixel unit is disposed on the substrate and includes a power generating structure. The power generating structure includes a first electrode, a second electrode and a transparent semiconductor layer. The first electrode includes a metal reflective layer. The second electrode is disposed on the first electrode and includes a transparent conductive layer. The transparent semiconductor layer is disposed between the first electrode and the second electrode, and the transparent semiconductor layer is electrically connected to the first electrode and the second electrode.

### BACKGROUND OF THE INVENTION

### 1. Field of the Invention

The present invention relates to a display panel and manufacturing method thereof, and more particularly, to a display panel having a display function and a power-generating function, and to a related manufacturing method.

### 2. Description of the Prior Art

Since the display panel has the characteristics of thin appearance, light weight, low power consumption and no radiation pollution, it has been widely used in many kinds of electronic products, such as notebooks, smart phones, portable devices, smart watches, and display devices in vehicles, for transmitting and displaying information more conveniently. A type of display panel (such as a reflective display panel or a transflective display panel) uses an external light (e.g., an ambient light) as a light source, such that this type of display panel has the effect of protecting the user's eyes, and has the advantages of low power consumption and/or low heat production. Therefore, the industry is committed to developing this type of display panel.

### SUMMARY OF THE INVENTION

It is therefore a primary objective of the present invention to provide a display panel capable of displaying an image by reflecting an external light and generating power by absorbing the external light, so as to make the display panel have a display function and a power-generating function. Furthermore, the present invention further provides a manufacturing method of this display panel.

In order to solve the above technical problems, the present invention provides a display panel including a substrate and a plurality of pixel units. The pixel units are disposed on the substrate, and each of the pixel units includes a power generating structure. The power generating structure includes a first electrode, a second electrode and a transparent semiconductor layer. The first electrode includes a metal reflective layer. The second electrode is disposed on the first electrode, and the second electrode includes a transparent conductive layer. The transparent semiconductor layer is disposed between the first electrode and the second electrode, and the transparent semiconductor layer is electrically connected to the first electrode and the second electrode.

In order to solve the above technical problems, the present invention further provides a manufacturing method of a display panel, wherein the display panel includes a plurality of pixel units, and each of the pixel units includes a power generating structure. The manufacturing method includes: forming a first electrode of the power generating structure on a substrate, wherein the first electrode includes a metal reflective layer; forming a transparent semiconductor layer of the power generating structure on the first electrode; and forming a second electrode of the power generating structure on the transparent semiconductor layer, wherein the second electrode includes a transparent conductive layer.

### BRIEF DESCRIPTION OF THE DRAWINGS

FIG. 1 is a schematic diagram of a cross-sectional view illustrating a display panel according to a first embodiment of the present invention.

FIG. 2 is a schematic diagram of a cross-sectional view illustrating a pixel unit of the display panel according to the first embodiment of the present invention.

FIG. 3 is a schematic diagram of a cross-sectional view illustrating the pixel unit having a first conductive layer with a multi-layer structure according to the first embodiment of the present invention.

FIG. 4 is a schematic diagram illustrating a reflectivity of the first conductive layer of the display panel for light of various wavelengths according to an embodiment of the present invention.

FIG. 5 is a schematic diagram illustrating an absorptivity of the transparent semiconductor layer of the display panel for light of various wavelengths according to an embodiment of the present invention.

FIG. 6 is a schematic diagram illustrating an absorptivity of the transparent semiconductor layer of the display panel for light of various wavelengths according to another embodiment of the present invention.

FIG. 7 is a schematic diagram of a cross-sectional view illustrating the display panel having the transparent semiconductor layer shown in FIG. 6 according to the first embodiment of the present invention.

FIG. 8 is a schematic diagram of a cross-sectional view illustrating a display panel according to a variation of the first embodiment of the present invention.

FIG. 9 is a schematic diagram of a cross-sectional view illustrating a pixel unit of the display panel according to the variation of the first embodiment of the present invention.

FIG. 10 is a schematic diagram of a cross-sectional view illustrating a display panel according to a second embodiment of the present invention.

FIG. 11 is a schematic diagram of a cross-sectional view illustrating a pixel unit of the display panel according to the second embodiment of the present invention.

FIG. 12 is a schematic diagram of a top view illustrating a conductive layer in the pixel unit of the display panel according to the second embodiment of the present invention.

FIG. 13 is a schematic diagram of a cross-sectional view illustrating a display panel according to a third embodiment of the present invention.

FIG. 14 is a schematic diagram of a cross-sectional view illustrating a pixel unit of the display panel according to the third embodiment of the present invention.

FIG. 15 is a schematic diagram of a top view illustrating power generating structures in the pixel units of the display panel according to the third embodiment of the present invention.

FIG. 16 is a schematic diagram of a cross-sectional view illustrating a pixel unit of a display panel according to a fourth embodiment of the present invention.

FIG. 17 to FIG. 20 are schematic diagrams illustrating structures at different stages of a manufacturing method of a display panel according to an embodiment of the present invention.

### DETAILED DESCRIPTION

The present invention may be understood by reference to the following detailed description, taken in conjunction with the drawings as described below. It is noted that, for purposes of illustrative clarity and being easily understood by the readers, various drawings of this disclosure show a portion of a display panel in this disclosure, and certain elements in various drawings may not be drawn to scale. In addition, the number and dimension of each device shown in drawings are only illustrative and are not intended to limit the scope of the present invention.

In the following description and in the claims, the terms “include”, “comprise” and “have” are used in an open-ended fashion, and thus should be interpreted to mean “include, but not limited to . . . ”. Thus, when the terms “include”, “comprise” and/or “have” are used in the description of the present invention, the corresponding features, areas, steps, operations and/or components would be pointed to existence, but not limited to the existence of one or a plurality of the corresponding features, areas, steps, operations and/or components.

In the following description and in the claims, when “a A1 component is formed by/of B1”, B1 exist in the formation of A1 component or B1 is used in the formation of A1 component, and the existence and use of one or a plurality of other features, areas, steps, operations and/or components are not excluded in the formation of A1 component.

In the description and following claims, the term “horizontal direction” generally means a direction parallel to a horizontal plane, the term “horizontal plane” generally means a surface parallel to a direction X and direction Y in the drawings, the term “vertical direction” generally means a direction parallel to a direction Z and perpendicular to the horizontal direction in the drawings, and the direction X, the direction Y and the direction Z are perpendicular to each other. In the description and following claims, the term “top view” generally means a viewing result viewing along the vertical direction. In the description and following claims, the term “cross-sectional view” generally means a structure cut along the vertical direction is viewed along the horizontal direction.

In the description and following claims, it should be noted that the term “overlap” means that two elements overlap along the direction Z, and the term “overlap” can be “partially overlap” or “completely overlap” in unspecified circumstances, wherein these two elements may be in contact with each other directly, or a spacing element exists between these two elements.

The terms “about”, “approximately”, “substantially”, “equal”, or “same” generally mean within ±10% of a given value or range, or mean within ±5%, ±3%, ±2%, ±1%, or ±0.5% of a given value or range.

Although terms such as first, second, third, etc., may be used to describe diverse constituent elements, such constituent elements are not limited by the terms. These terms are used only to discriminate a constituent element from other constituent elements in the specification, and these terms have no relation to the manufacturing order of these constituent components. The claims may not use the same terms, but instead may use the terms first, second, third, etc. with respect to the order in which an element is claimed. Accordingly, in the following description, a first constituent element may be a second constituent element in a claim.

It should be noted that the technical features in different embodiments described in the following can be replaced, recombined, or mixed with one another to constitute another embodiment without departing from the spirit of the present invention.

In the present invention, a display device includes a display panel, and the display panel uses an external light to be a light source for displaying. The external light enters the display panel from a side of the display panel facing to a user, and the display panel reflects the external light to display an image, wherein the aforementioned external light may be an ambient light (e.g., a solar light) for example, but not limited thereto. In some embodiments, the display device may further include a front light module, and the aforementioned external light may include the light provided from the front light module, wherein the front light module is disposed on the side of the display panel facing to the user. For instance, the display panel may be a reflective display panel, wherein the reflective display panel uses the aforementioned external light to be a light source for displaying, but not limited thereto. For instance, the display panel may be a transflective display panel and further include a backlight module, and the backlight module is disposed on a side of the display panel facing away from the user, wherein the transflective display panel uses not only the aforementioned external light but also the light provided from the backlight module to be light sources for displaying, but not limited thereto. Moreover, for instance, the display panel may be a liquid crystal display panel (LCD Panel), an electrophoretic display panel), an electrowetting display panel or other suitable display panel, but not limited thereto.

The display panel may be a color display panel or a monochrome display panel based on requirement(s), and the display panel may correspondingly include the required structures according to its display color(s). The display panel may include a plurality of pixels, and each pixel may include at least one pixel unit. In some embodiments, if the display panel is a color display panel, one pixel includes a plurality of pixel units (i.e., a plurality of pixel units form one pixel) for instance, and each pixel unit is a sub-pixel. For example, the pixel units may include a green sub-pixel, a red sub-pixel and a blue sub-pixel, but not limited thereto. The number and color(s) of the pixel unit(s) included in one pixel may be adjusted based on requirement(s). In some embodiments, if the display panel is a monochrome display panel, one pixel includes one pixel unit (i.e., one pixel unit is one pixel) for instance, but not limited thereto. The number, the arrangement and the shapes of the pixels and the number, the arrangement and the shapes of the pixel units may be designed based on requirement(s).

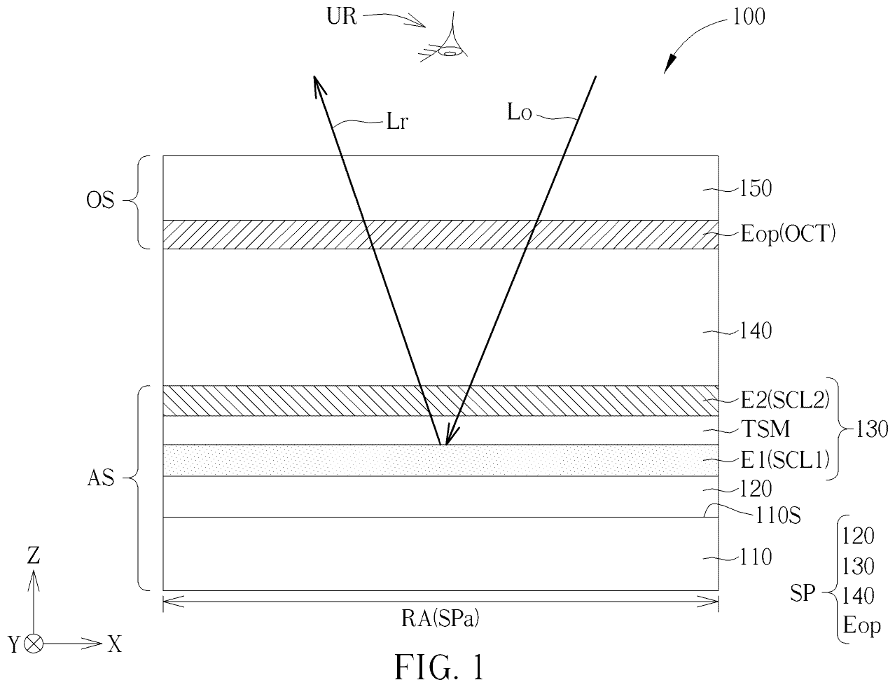

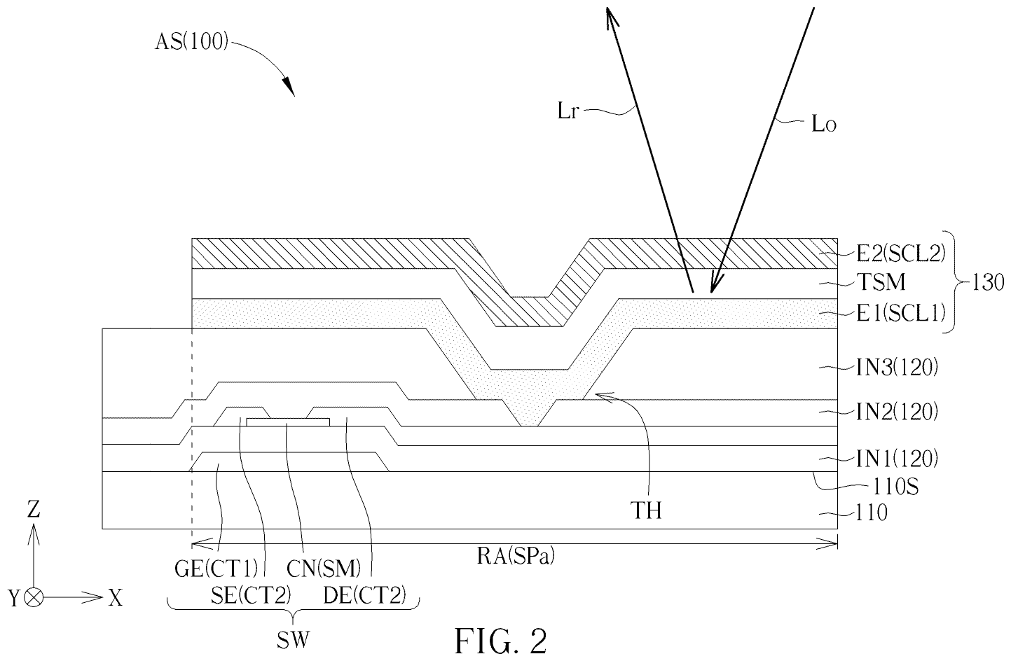

Referring to FIG. 1 and FIG. 2, FIG. 1 is a schematic diagram of a cross-sectional view illustrating a display panel according to a first embodiment of the present invention, and FIG. 2 is a schematic diagram of a cross-sectional view illustrating a pixel unit of the display panel according to the first embodiment of the present invention. As shown in FIG. 1 and FIG. 2, the display panel 100 includes a first substrate 110 and a second substrate 150 disposed opposite to the first substrate 110, wherein the first substrate 110 and the second substrate 150 may be rigid or flexible individually. Based on the type of the first substrate 110 and the type of the second substrate 150, the first substrate 110 and the second substrate 150 may individually include glass, plastic, quartz, sapphire, polymer (e.g., polyimide (PI), polyethylene terephthalate (PET), etc.), other suitable materials or a combination thereof, but not limited thereto. Note that the first substrate 110 and the second substrate 150 may have the same material or different materials, may have the same shape or different shapes, and may have the same size or different sizes. Moreover, in FIG. 1 and FIG. 2, a normal direction of the first substrate 110 and a normal direction of the second substrate 150 are parallel to the direction Z. In this embodiment, the pixel unit SP is disposed on a surface 110S of the first substrate 110, and the direction Z is perpendicular to the surface 110S of the first substrate 110.

As shown in FIG. 1 and FIG. 2, the display panel 100 includes a display medium layer 140 disposed between the first substrate 110 and the second substrate 150. The display medium layer 140 may include any suitable material according to the type of the display panel 100. In this embodiment, the display panel 100 may be a reflective liquid crystal display panel, such that the display medium layer 140 may include liquid crystal molecules, but not limited thereto. In other embodiments, the display medium layer may include an electrophoretic material or other suitable display medium material, but not limited thereto. The display medium material included in the display medium layer 140 may be adjusted by any suitable method, so as to adjust the status of a part of the display medium layer 140 corresponding to the pixel unit SP, thereby adjusting the light transmittance of this pixel unit SP. For instance, in some embodiments, the status of the display medium layer 140 may be controlled by an electric field (e.g., an electric field generated between a pixel electrode and a common electrode) and/or at least one electrical signal.

In the present invention, electrode(s) configured to control the status of the display medium layer 140 may be designed based on requirement(s). For instance, a plurality of electrodes configured to control the display medium layer 140 may be disposed on opposite sides of the display medium layer 140 (i.e., one electrode (e.g., the pixel electrode) may be disposed between the display medium layer 140 and the first substrate 110, and another electrode (e.g., the common electrode) may be disposed between the display medium layer 140 and the second substrate 150, such that the display medium layer 140 may be disposed between these electrodes (e.g., the pixel electrode and the common electrode)), but not limited thereto. For instance, a plurality of electrodes configured to control the display medium layer 140 may be disposed on the same side of the display medium layer 140 (e.g., the pixel electrode and the common electrode may be disposed between the display medium layer 140 and the first substrate 110), but not limited thereto. In some embodiments, each pixel unit SP may include at least two electrodes configured to control the display medium layer 140, so as to make the status of a part of the display medium material of the display medium layer 140 corresponding to the pixel unit SP be adjusted according to the electrical signals (e.g., the gray level signal) received by the electrodes, thereby adjusting the light transmittance of the pixel unit SP. For example, in the following, two electrodes (e.g., the pixel electrode and the common electrode) configured to control the display medium layer 140 may be disposed on opposite sides of the display medium layer 140, but not limited thereto.

As shown in FIG. 1 and FIG. 2, a circuit component layer 120 is disposed on the first substrate 110 and disposed between the display medium layer 140 and the first substrate 110. The circuit component layer 120 may include at least one conductive layer, at least one insulating layer, at least one semiconductor layer or a combination thereof, so as to form electronic components in the circuit component layer 120. The material of the conductive layer may include such as metal, transparent conductive material (such as indium tin oxide (ITO), indium zinc oxide (IZO), etc.), other suitable conductive material(s) or a combination thereof, but not limited thereto. The material of the insulating layer may include such as inorganic insulating material (e.g., silicon oxide (SiOx), silicon nitride (SiNy), silicon oxynitride (SiOxNy)), organic insulating material (e.g., photosensitive resin), other suitable insulating material(s) or a combination thereof, but not limited thereto. The material of the semiconductor layer may include such as poly-silicon, amorphous silicon, metal-oxide semiconductor, other suitable semiconductor material(s) or a combination thereof, but not limited thereto. For example, in FIG. 2, a conductive layer CT1, an insulating layer IN1, a semiconductor layer SM, a conductive layer CT2, an insulating layer IN2 and an insulating layer IN3 are disposed on the first substrate 110 in sequence, wherein the conductive layer CT1 and the conductive layer CT2 may be metal conductive layers, and the insulating layer IN3 may be a flatten layer, but not limited thereto. In some embodiments, the display panel 100 may not include the insulating layer IN3.

The circuit component layer 120 may include any suitable electronic component, and the electronic component may be formed of the aforementioned layer(s) in the circuit component layer 120. In FIG. 2, the circuit component layer 120 may include at least one switching component SW disposed in the pixel unit SP, wherein the switching component SW may be a top gate thin film transistor, a bottom gate thin film transistor, a dual gate thin film transistor or other suitable switching component (the switching component SW shown in FIG. 2 is a bottom gate thin film transistor for example). For instance, the conductive layer CT1 may include a gate GE of the switching component SW, the insulating layer IN1 may include a gate insulating layer of the switching component SW, the semiconductor layer SM may include a channel layer CN of the switching component SW, and the conductive layer CT2 may include a source SE and a drain DE of the switching component SW, but not limited thereto. Although FIG. 2 only shows one switching component SW in the pixel unit SP, the number of the switching component(s) SW in the pixel unit SP may be designed based on requirement(s).

In some embodiments, the circuit component layer 120 may further include at least one scan line and at least one data line, wherein the scan line may be configured to transmit switching signal for turning on or turning off the switching component SW, the data line may be configured to transmit the electrical signal related to the status of the display medium layer 140 (e.g., the gray level signal). For instance, the scan line may be electrically connected to the gate GE of the switching component SW, the scan line and the gate GE may be formed of the same layer (i.e., the conductive layer CT1 may include the scan line), the data line may be electrically connected to the source SE of the switching component SW, and the data line and the source SE may be formed of the same layer (i.e., the conductive layer CT2 may include the data line), but not limited thereto.

In the present invention (as shown in FIG. 1 and FIG. 2), the display panel 100 includes a conductive layer (or referred as a first conductive layer) SCL1 disposed between the first substrate 110 and the second substrate 150, wherein the conductive layer SCL1 serves as a light-reflected layer of the display panel 100 to reflect the external light Lo, such that the display panel 100 uses the external light Lo for displaying, so as to make the user UR see the display image. In order to make the conductive layer SCL1 have a good reflection effect on the external light Lo, the conductive layer SCL1 may be a single-layer structure or a multi-layer structure which include a metal reflective layer, wherein the metal reflective layer is configured to reflect the external light Lo. In some embodiments, the material of the metal reflective layer may include metal material(s) with high reflectivity, such as silver, aluminum or other suitable metal material. Specifically, the pixel unit SP has a display region SPa, and the display region SPa of the pixel unit SP is configured to display an image, wherein the display region SPa has a reflective region RA, and the reflective region RA of the pixel unit SP reflect a part of the external light Lo to form the display image. The conductive layer SCL1 is disposed in the reflective region RA of the display region SPa, wherein the conductive layer SCL1 includes the metal reflective layer and is configured to reflect the external light Lo for displaying the corresponding image.

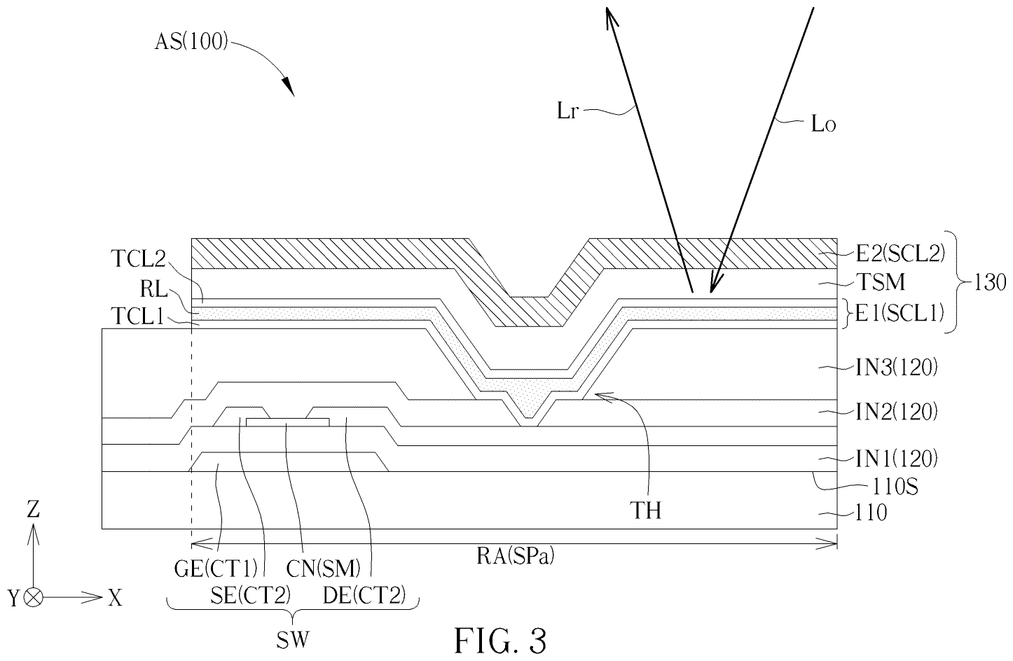

For example, referring to FIG. 3, FIG. 3 is a schematic diagram of a cross-sectional view illustrating the pixel unit of the display panel according to the first embodiment of the present invention, wherein the first conductive layer (the conductive layer SCL1) is a multi-layer structure. As shown in FIG. 3, the conductive layer SCL1 may be a multi-layer structure and include two transparent conductive layers TCL1 and TCL2 (e.g., the transparent conductive layers TCL1 and TCL2 may individually include ITO, IZO or other suitable transparent conductive material(s), and the transparent conductive layers TCL1 and TCL2 may have the same material or different materials) and a metal reflective layer RL disposed between two transparent conductive layers TCL1 and TCL2 in the direction Z (i.e., the transparent conductive layer TCL1, the metal reflective layer RL and the transparent conductive layer TCL2 may be stacked), but not limited thereto. In another embodiment, the conductive layer SCL1 may be a multi-layer structure and include the metal reflective layer RL and one of two transparent conductive layers TCL1 and TCL2. In still another embodiment, the conductive layer SCL1 may be a single-layer structure and include the metal reflective layer RL.

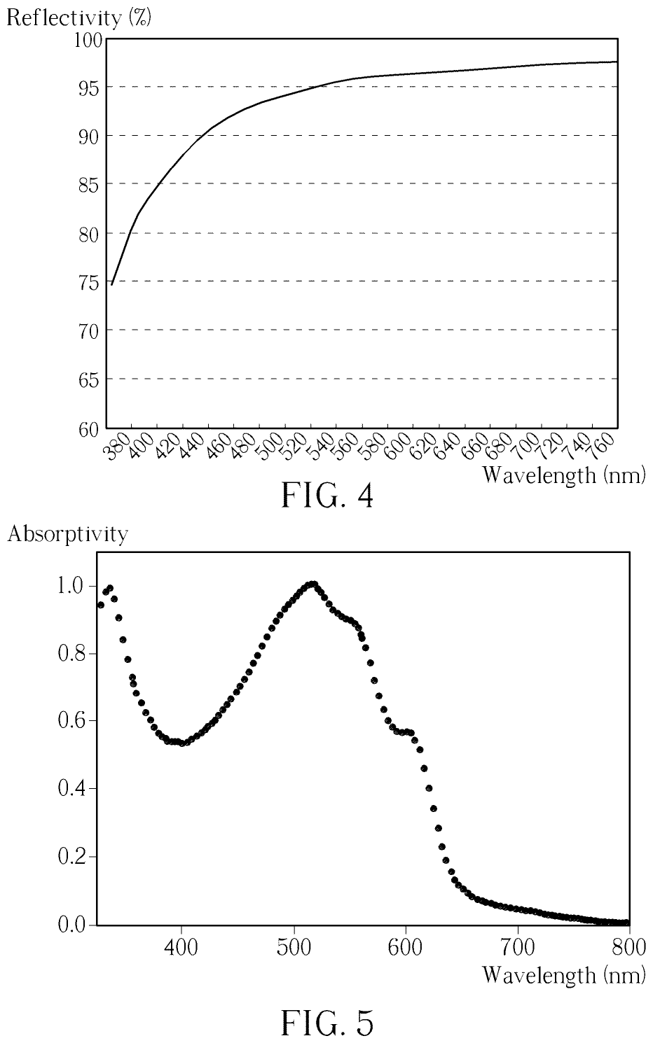

Referring to FIG. 3 and FIG. 4, FIG. 4 is a schematic diagram illustrating a reflectivity of the first conductive layer of the display panel for light of various wavelengths according to an embodiment of the present invention, wherein the conductive layer SCL1 of the embodiment corresponding to FIG. 4 includes two transparent conductive layers TCL1 and TCL2 and the metal reflective layer RL disposed between two transparent conductive layers TCL1 and TCL2 (as shown in FIG. 3), the materials of two transparent conductive layers TCL1 and TCL2 are ITO, a thickness of the transparent conductive layer TCL2 close to the display medium layer 140 is approximately 50 Å, a thickness of the transparent conductive layer TCL1 away from the display medium layer 140 is approximately 80 Å, the material of the metal reflective layer RL is silver, and a thickness of the metal reflective layer RL is approximately 1500 Å. As shown in FIG. 4, the conductive layer SCL1 has a high reflectivity for the external light Lo, wherein this conductive layer SCL1 has a reflectivity greater than or equal to 75% for the light with a wavelength ranging from 380 nm to 780 nm, and has a reflectivity greater than or equal to 95% for the light with a greater wavelength in above range (e.g., a wavelength ranging from 550 nm to 780 nm). Accordingly, a reflected light Lr with sufficient light intensity may be formed by reflecting the external light Lo through the conductive layer SCL1, such that the display panel 100 may use this reflected light Lr to display an image. In this embodiment, as shown in FIG. 1 and FIG. 2, since the external light Lo and the reflected light Lr passes through the second substrate 150, the second substrate 150 is a light-transmitting substrate.

In the present invention, the display panel 100 includes a power generating structure 130 disposed between the first substrate 110 and the second substrate 150, wherein the power generating structure 130 is configured to absorb a part of the external light Lo and convert it into a photocurrent. In this embodiment, as shown in FIG. 1 and FIG. 2, the power generating structure 130 may be disposed in the reflective region RA of the display region SPa of the pixel unit SP, and the power generating structure 130 may include a first electrode E1, a transparent semiconductor layer TSM and a second electrode E2. The transparent semiconductor layer TSM is disposed between the first electrode E1 and the second electrode E2, the transparent semiconductor layer TSM is electrically connected to the first electrode E1 and the second electrode E2, and the second electrode E2 is disposed between the transparent semiconductor layer TSM and the display medium layer 140. In some embodiments, other film(s) (e.g., an electronic hole transporting layer and/or an electron transporting layer) may be optionally disposed between the transparent semiconductor layer TSM and the first electrode E1 and/or disposed between the transparent semiconductor layer TSM and the second electrode E2, but not limited thereto. In the present invention, the transparent semiconductor layer TSM may be referred as a photoactive layer. The transparent semiconductor layer TSM may absorb a part of the external light Lo and convert it into the photocurrent, and the photocurrent may be stored into a battery (or a capacitor) in the display device through the first electrode E1 and the second electrode E2 (the battery and the capacitor are not shown in figures), thereby charging the display device.

As shown in FIG. 1 and FIG. 2, the conductive layer SCL1 disposed between the first substrate 110 and the second substrate 150 may include the first electrode E1 of the power generating structure 130. As shown in FIG. 1 and FIG. 2, the display panel 100 may further include a conductive layer (or referred as a second conductive layer) SCL2 disposed between the first substrate 110 and the second substrate 150, and the conductive layer SCL2 may include the second electrode E2 of the power generating structure 130. The conductive layer SCL2 includes a transparent conductive layer including transparent conductive material(s) (e.g., ITO, IZO, etc.), so as to make the external light Lo and the reflected light Lr pass through the conductive layer SCL2. Since the transparent semiconductor layer TSM is disposed between the first electrode E1 and the second electrode E2, the transparent semiconductor layer TSM is disposed between the conductive layer SCL1 and the conductive layer SCL2.

In the present invention, the transparent semiconductor layer TSM may include any suitable material, and the transparent semiconductor layer TSM may be a single-layer structure or a multi-layer structure, wherein the transparent semiconductor layer TSM may absorb the external light Lo in a specific wavelength range depending on the material it contains (e.g., the transparent semiconductor layer TSM may absorb a visible light, an infrared light and/or an ultraviolet light), so as to convert a part of the external light Lo into the photocurrent for generating electricity. In some embodiments, the transparent semiconductor layer TSM may be a multi-layer structure, and a PN junction may exist in the transparent semiconductor layer TSM, so as to make the transparent semiconductor layer TSM perform the photoelectric conversion.

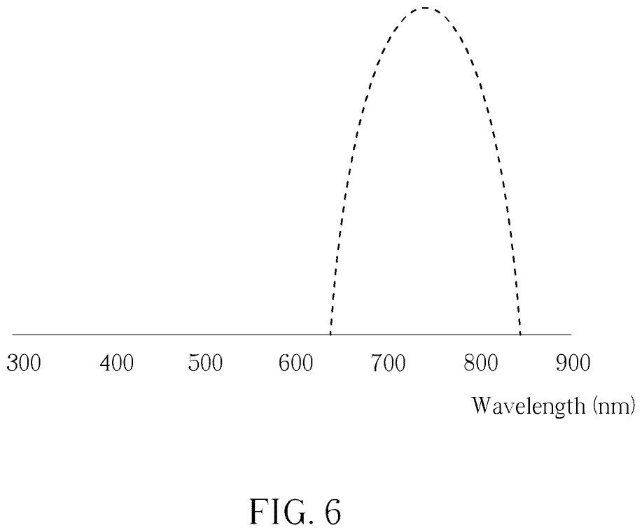

In some embodiments, the transparent semiconductor layer TSM may include PCBM (phenyl C61-butyric acid methyl ester), P3HT (poly (3-hexylthiophene)), transition-metal dichalcogenide (TMD), other suitable metal compound(s) or a combination thereof, so as to absorb a part of the visible light in the external light Lo and convert this part of the visible light into the photocurrent. In some options of the material of the transparent semiconductor layer TSM, the transparent semiconductor layer TSM absorb not only a part of the visible light but also a part of the infrared light and/or a part of the ultraviolet light. Referring to FIG. 5, FIG. 5 is a schematic diagram illustrating an absorptivity of this type of transparent semiconductor layer for light of various wavelengths, wherein this transparent semiconductor layer TSM includes PCBM and P3HT. In FIG. 5, the transparent semiconductor layer TSM including PCBM and P3HT has a high absorptivity for the light with a wavelength ranging from 400 nm to 650 nm. For example, if a visible light band is defined as the wavelength ranging from 450 nm to 650 nm, and the near-infrared (NIR) light band is defined as the wavelength ranging from 650 nm to 1400 nm, as shown in FIG. 5, the transparent semiconductor layer TSM including PCBM and P3HT has a high absorptivity for the light in the visible light band, an absorption peak exists in the visible light band (the absorption peak is approximately corresponding to the wavelength of 520 nm), and the transparent semiconductor layer TSM has a low absorptivity for the light in the near-infrared light band. Note that this type of transparent semiconductor layer TSM may be referred as a visible-light-absorbing transparent semiconductor layer.

According to FIG. 4 and FIG. 5, the transparent semiconductor layer TSM including PCBM and P3HT has a high absorptivity for the light with a wavelength ranging from 400 nm to 650 nm, and the conductive layer SCL1 has a reflectivity greater than or equal to 80% (e.g., 80% to 95% or greater) for the light with a wavelength ranging from 400 nm to 650 nm. Therefore, as shown in FIG. 1 and FIG. 2, when the external light Lo irradiates the transparent semiconductor layer TSM, the transparent semiconductor layer TSM performs the photoelectric conversion to convert a part of the external light Lo into the photocurrent (e.g., the photoelectric conversion is performed on a part of the visible light in the external light Lo). Then, since the conductive layer SCL1 includes the metal reflective layer (i.e., the first electrode E1 of the power generating structure 130 includes the metal reflective layer (e.g., the metal reflective layer RL shown in FIG. 3)), the remaining external light Lo passing through the transparent semiconductor layer TSM is reflected by the first electrode E1 of the power generating structure 130 to form the reflected light Lr. Next, the reflected light Lr enters the transparent semiconductor layer TSM, such that the transparent semiconductor layer TSM performs the photoelectric conversion to convert a part of the reflected light Lr into the photocurrent (e.g., the photoelectric conversion is performed on a part of the visible light in the reflected light Lr). The remaining reflected light Lr passing through the transparent semiconductor layer TSM is seen by the user UR after passing through the second electrode E2 of the power generating structure 130, such that the user UR would see the display image. Accordingly, the conductive layer SCL1 is further configured to enhance the utilization rate of the external light Lo, and to enhance the photocurrent generated by the power generating structure 130.

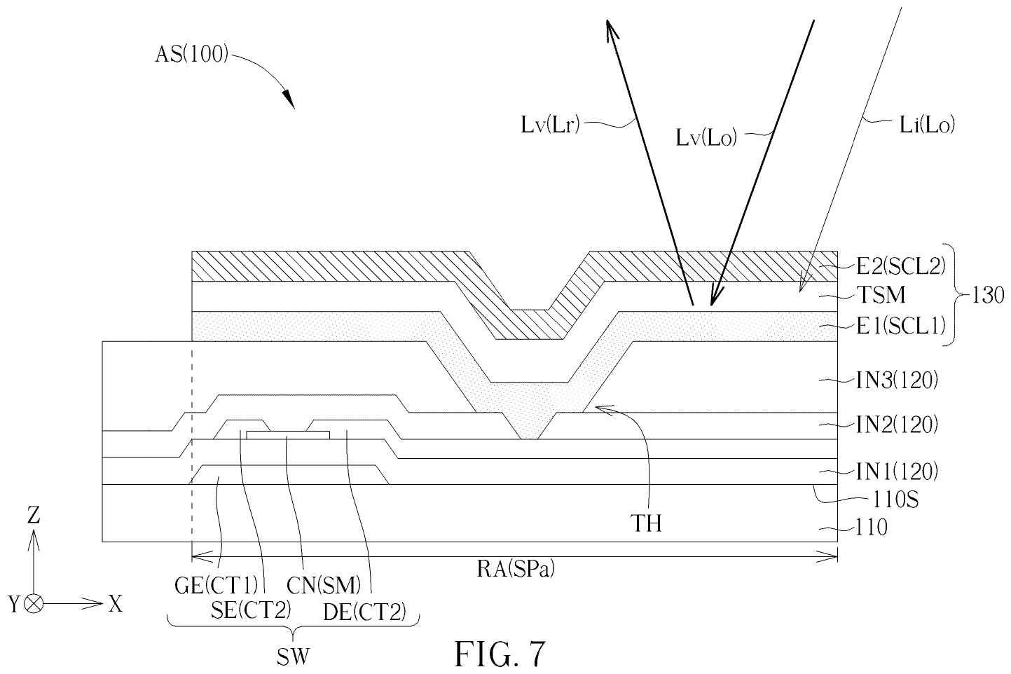

Another type of transparent semiconductor layer TSM is further provided by the present invention, wherein the photoelectric conversion performed by the transparent semiconductor layer TSM is performed on the light with another wavelength range. In some embodiments, the transparent semiconductor layer TSM may include fullerene (C60), silicon naphthalocyanine (SiNc), titanium oxide (e.g., titanium dioxide (TiO₂)), nickel oxide (NiO) or a combination thereof, so as to absorb a part of the infrared light (e.g., the near-infrared light) in the external light Lo and convert it into the photocurrent. In some cases, the transparent semiconductor layer TSM absorbs not only a part of the infrared light but also a part of the visible light (e.g., a small amount of the visible light). For instance, the transparent semiconductor layer TSM may include two sub-layers, one of the sub-layers may include fullerene, nickel oxide or a combination thereof, and another one of sub-layers may include silicon naphthalocyanine, titanium oxide or a combination thereof, but not limited thereto. Referring to FIG. 6, FIG. 6 is a schematic diagram illustrating an absorptivity of this type of transparent semiconductor layer for light of various wavelengths. In FIG. 6, the transparent semiconductor layer TSM may have an absorption peak in a wavelength band greater than 650 nm (e.g., the transparent semiconductor layer TSM may have a high absorptivity for the light with a wavelength greater than 650 nm and less than or equal to 850 nm). Also, compared with the absorptivity of the transparent semiconductor layer TSM for the light with a wavelength greater than 650 nm, the absorptivity of the transparent semiconductor layer TSM for the light with a wavelength less than 650 nm is much smaller. Thus, this type of transparent semiconductor layer TSM may absorb a part of the infrared light (e.g., the near-infrared light) and a small amount of the visible light in the external light Lo. Specifically, this type of transparent semiconductor layer TSM may have a high absorptivity for the light in the near-infrared light band, the absorption peak exists in the near-infrared light band (e.g., the absorption peak shown in FIG. 6 may be approximately corresponding to the wavelength between 700 nm to 800 nm), and this type of transparent semiconductor layer TSM may have a low absorptivity for the light in the visible light band. Note that this type of transparent semiconductor layer TSM may be referred as a near-infrared-light-absorbing transparent semiconductor layer.

According to FIG. 4 and FIG. 6, this type of the transparent semiconductor layer TSM has a high absorptivity for the light in the near-infrared light band, and the conductive layer SCL1 has a reflectivity greater than 95% for the light with a wavelength greater than 650 nm. Therefore, when the external light Lo irradiates the transparent semiconductor layer TSM, the transparent semiconductor layer TSM performs the photoelectric conversion to convert a part of the external light Lo into the photocurrent (e.g., the photoelectric conversion is performed on a part of the near-infrared light in the external light Lo). Then, the remaining external light Lo passing through the transparent semiconductor layer TSM is reflected by the first electrode E1 of the power generating structure 130 to form the reflected light Lr. Next, the reflected light Lr enters the transparent semiconductor layer TSM, such that the transparent semiconductor layer TSM performs the photoelectric conversion to convert a part of the reflected light Lr into the photocurrent (e.g., the photoelectric conversion is performed on a part of the near-infrared light in the reflected light Lr). The remaining reflected light Lr passing through the transparent semiconductor layer TSM is seen by the user UR after passing through the second electrode E2 of the power generating structure 130, such that the user UR would see the display image.

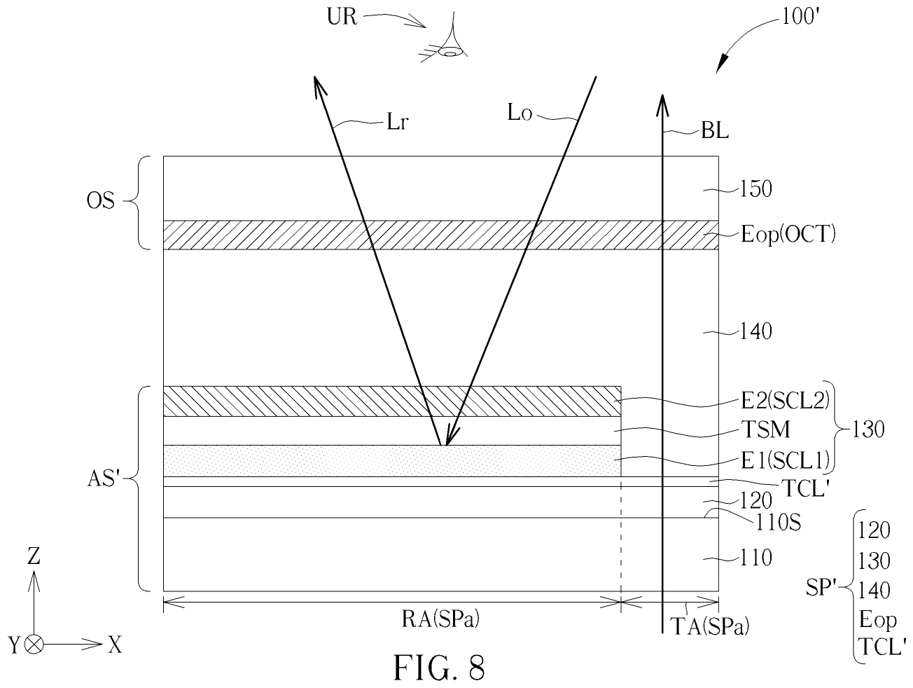

Referring to FIG. 7, FIG. 7 is a schematic diagram of a cross-sectional view illustrating the display panel 100 having the transparent semiconductor layer TSM mainly absorbing the near-infrared light, wherein coarse lines shown in FIG. 7 represent the visible light Lv, and a fine line shown in FIG. 7 represents the near-infrared light Li. As shown in FIG. 7, the transparent semiconductor layer TSM mainly performs the photoelectric conversion on the near-infrared light Li to make the near-infrared light Li be greatly absorbed, and the transparent semiconductor layer TSM absorb a small amount of the visible light Lv. Therefore, the attenuation of the visible light Lv in the transparent semiconductor layer TSM may be reduced, thereby increasing the intensity of the visible light Lv in the reflected light Lr, improving the contrast of the display image, and reducing the thermal effect caused by the near-infrared light Li of the external light Lo on the display panel 100. As shown in FIG. 6 and FIG. 7, since this type of transparent semiconductor layer TSM has a high absorptivity for the light in the near-infrared light band and has a low absorptivity for the light in the visible light band, most of the near-infrared light Li in the external light Lo is absorbed by the transparent semiconductor layer TSM and converted by the photoelectric conversion, and most of the visible light Lv in the external light Lo is reflected by the conductive layer SCL1. Therefore, FIG. 7 shows the visible light Lv in the reflected light Lr and omits the near-infrared light Li in the reflected light Lr.

Moreover, in the present invention (as shown in FIG. 1 and FIG. 2), the conductive layer SCL1 having a well light-reflecting effect includes the first electrode E1 of the power generating structure 130, and the power generating structure 130 is disposed in the reflective region RA of the display region SPa of the pixel unit SP. Namely, the first electrode E1 of the power generating structure 130 not only serves as a light-reflected layer of the display panel 100 to reflect the external light Lo for displaying, but also serves as an electrode of the power generating structure 130. Thus, the number of the required layers in the display panel 100 may be reduced, thereby reducing the cost of the display panel 100 including the power generating structure 130.

In the present invention, the power generating structure 130 may be disposed at any suitable position between the first substrate 110 and the second substrate 150. In some embodiments, as shown in FIG. 1 and FIG. 2, the power generating structure 130 may be disposed between the circuit component layer 120 including the switching component SW and the display medium layer 140 (i.e., the circuit component layer 120 may be between the first substrate 110 and the power generating structure 130). Therefore, the circuit component layer 120, the conductive layer SCL1, the transparent semiconductor layer TSM and the conductive layer SCL2 may be disposed between the first substrate 110 and the display medium layer 140, the first electrode E1 of the power generating structure 130 may be disposed between the circuit component layer 120 and the transparent semiconductor layer TSM, and the second electrode E2 of the power generating structure 130 may be disposed between the display medium layer 140 and the transparent semiconductor layer TSM, but not limited thereto. Since the first electrode E1 of the power generating structure 130 includes the metal reflective layer (e.g., the metal reflective layer RL shown in FIG. 3), the first electrode E1 of the power generating structure 130 not only serves as an electrode of the power generating structure 130, but also reflects the external light Lo to form the reflected light Lr for making the transparent semiconductor layer TSM perform the photoelectric conversion again and being transmitted to the user UR for making the user UR see the display image. Since the second electrode E2 of the power generating structure 130 is a transparent electrode and includes the transparent conductive layer, the external light Lo could pass through the second electrode E2 to enter the transparent semiconductor layer TSM, and the reflected light Lr could pass through the second electrode E2 to be seen by the user UR. Furthermore, since the transparent semiconductor layer TSM of the power generating structure 130 is a light-transmitting photoactive layer, a part of the external light Lo which is not absorbed by the transparent semiconductor layer TSM is reflected by the first electrode E1 to form the reflected light Lr, and a part of the reflected light Lr which is not absorbed by the transparent semiconductor layer TSM passes through the second electrode E2 and is seen by the user UR.

As shown in FIG. 1 and FIG. 2, an array substrate structure AS of the display panel 100 includes the first substrate 110, the circuit component layer 120, the conductive layer SCL1, the transparent semiconductor layer TSM and the conductive layer SCL2.

In some embodiments, the switching component SW may be electrically connected to the first electrode E1 or the second electrode E2 of the power generating structure 130 (in FIG. 1 and FIG. 2, the first electrode E1 of the power generating structure 130 is coupled to the switching component SW for instance), so as to make the first electrode E1 or the second electrode E2 serve as the pixel electrode and receive the gray level signal, thereby adjusting the status of the display medium layer 140. In some embodiments, since the first electrode E1 or the second electrode E2 of the power generating structure 130 serves as not only the pixel electrode but also the electrode of the power generating structure 130, the first electrode E1 or the second electrode E2 may serve as the pixel electrode corresponding to the pixel unit SP to receive the gray level signal during a display period of the display panel 100, and may serve as the electrode of the power generating structure 130 to transmit the photocurrent during a charging period of the display panel 100 (i.e., the first electrode E1 or the second electrode E2 may respectively receive the gray level signal and the photocurrent in different periods), so as to reduce the interaction between the display function and the charging function. For instance, in FIG. 2, the first electrode E1 of the power generating structure 130 may be electrically connected to the drain DE of the switching component SW through a through hole TH passing through the insulating layer IN3 and the insulating layer IN2, so as to make the first electrode E1 serve as the pixel electrode and receive the gray level signal, but not limited thereto. For instance (not shown in figures), the second electrode E2 of the power generating structure 130 may be electrically connected to the drain DE of the switching component SW, so as to make the second electrode E2 serve as the pixel electrode and receive the gray level signal, but not limited thereto.

In some embodiments (as shown in FIG. 1 and FIG. 2), since the first electrode E1 or the second electrode E2 of the power generating structure 130 may be electrically connected to the switching component SW to serve as the pixel electrode, the power generating structure 130 may be disposed in the pixel unit SP. In some embodiments (as shown in FIG. 1 and FIG. 2), the power generating structure 130 may occupy most of the area in the pixel unit SP (e.g., a ratio of an area of the power generating structure 130 to an area of the pixel unit SP may be greater than or equal to 0.5 and less than or equal to 1), but not limited thereto.

As shown in FIG. 1, the display panel 100 may include a conductive layer OCT disposed on the second substrate 150, such that the conductive layer OCT may be disposed between the display medium layer 140 and the second substrate 150, wherein the conductive layer OCT may be transparent and include transparent conductive material (e.g., ITO, IZO, etc.), so as to make the external light Lo and the reflected light Lr pass through the conductive layer OCT. In some embodiments, the conductive layer OCT may include a common electrode Eop, wherein the electric field generated by the common electrode Eop and the pixel electrode may adjust the status of the display medium layer 140. For example, the common electrode Eop of the conductive layer OCT may receive a common signal, but not limited thereto. In addition, as shown in FIG. 1, an opposite substrate structure OS of the display panel 100 includes the second substrate 150 and the conductive layer OCT, and the display medium layer 140 exists between the array substrate structure AS and the opposite substrate structure OS.

As shown in FIG. 1, the external light Lo of this embodiment enters the display panel 100 from a side of the second substrate 150 opposite to the display medium layer 140. Therefore, the external light Lo passes through the opposite substrate structure OS, the display medium layer 140, the conductive layer SCL2 and the transparent semiconductor layer TSM (the transparent semiconductor layer TSM performs the photoelectric conversion) in sequence. Then, the reflected light Lr reflected by the conductive layer SCL1 passes through the transparent semiconductor layer TSM (the transparent semiconductor layer TSM performs the photoelectric conversion again), the conductive layer SCL2, the display medium layer 140 and the opposite substrate structure OS in sequence. Finally, the reflected light Lr is emitted from the display panel 100 for displaying.

In the present invention, the display panel 100 may further include other suitable layer(s), component(s) and/or structure(s) based on requirement(s). In some embodiments, if the display panel 100 is a color display panel, the display panel 100 may further include a color conversion layer disposed between the first substrate 110 and the second substrate 150, so as to convert (or filter) the light (e.g., the white light) into another light with different color. The color conversion layer may include color filter, quantum dots (QD) material, fluorescence material, phosphorescence material, other suitable material(s) or a combination thereof, but not limited thereto. In some embodiments, the color conversion layer may be included in the opposite substrate structure OS. For example, the color conversion layer may be disposed between the second substrate 150 and the conductive layer OCT and be disposed between the second substrate 150 and the display medium layer 140 (i.e., the conductive layer OCT may be disposed between the color conversion layer and the display medium layer 140), but not limited thereto.

In some embodiments, the display panel 100 may include a light shielding layer having a light-shielding effect, wherein the light shielding layer may be disposed between the first substrate 110 and the second substrate 150. For example, the light shielding layer may include black photoresist, black ink, black resin, black pigment, metal, other suitable material(s) or a combination thereof. In some embodiments, the light shielding layer may be included in the opposite substrate structure OS, so as to shield some components (e.g., opaque components or opaque traces) or regions with poor display effect, thereby enhancing the display quality of the display panel 100, but not limited thereto. In another embodiment, the light shielding layer may be included in the array substrate structure AS. Furthermore, in some embodiments, the light shielding layer may have a plurality of openings configured to define the display region SPa of the pixel unit SP.

The display panel of the present disclosure is not limited to the above embodiments. Further embodiments of the present disclosure are described below. For ease of comparison, same components will be labeled with the same symbol in the following. The following descriptions relate the differences between each of the embodiments, and repeated parts will not be redundantly described.

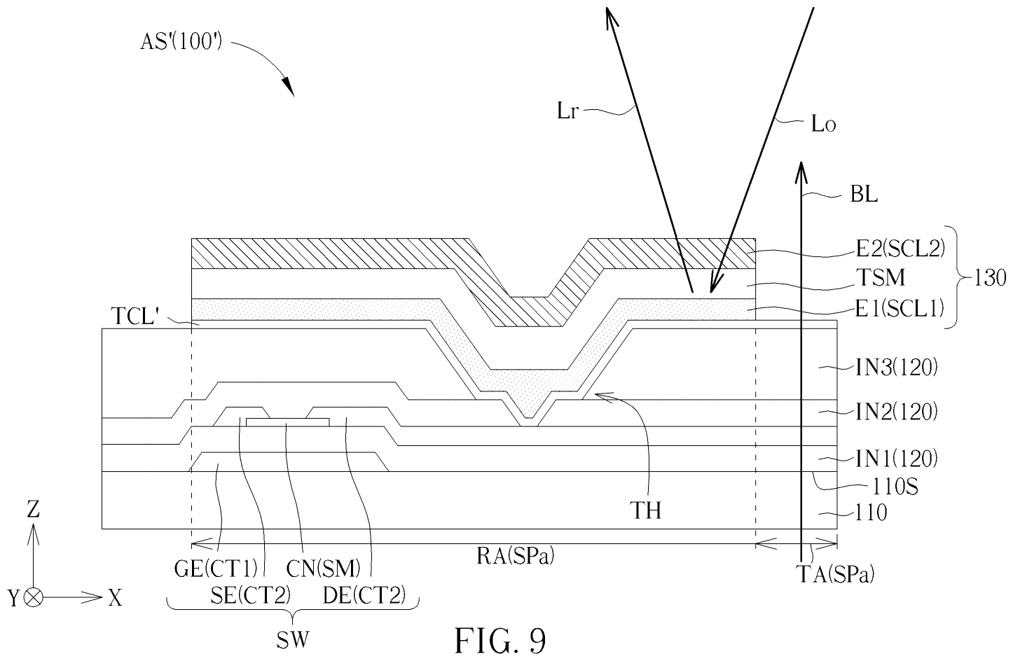

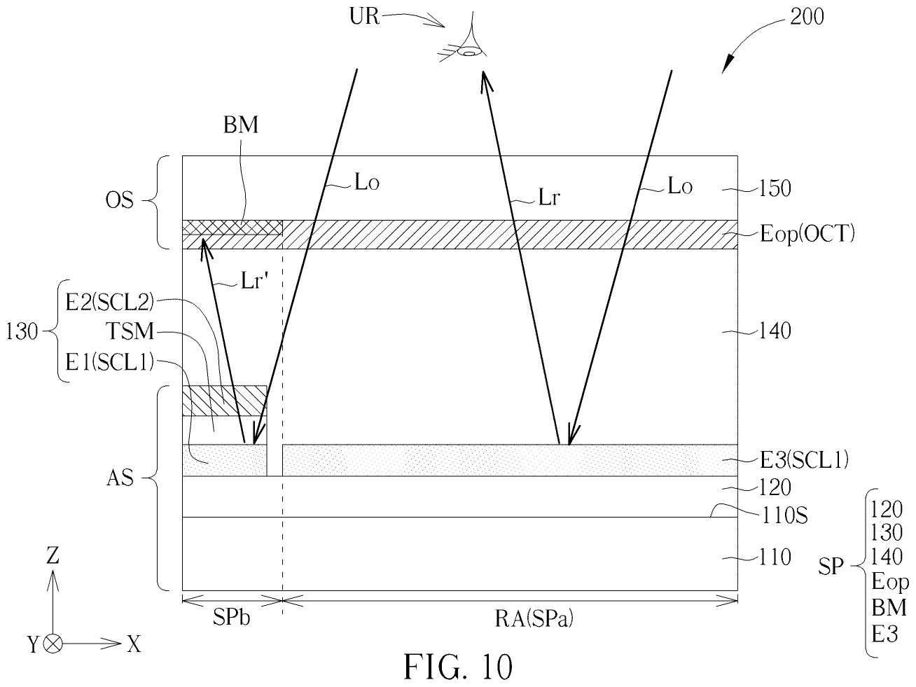

Referring to FIG. 8 and FIG. 9, FIG. 8 is a schematic diagram of a cross-sectional view illustrating a display panel according to a variation of the first embodiment of the present invention, and FIG. 9 is a schematic diagram of a cross-sectional view illustrating a pixel unit of the display panel according to the variation of the first embodiment of the present invention. As shown in FIG. 8 and FIG. 9, a difference between this variant embodiment and the first embodiment is that the display region SPa of the pixel unit SP′ of the display panel 100′ of this variant embodiment further has a light-transmitting region TA, and the pixel unit SP′ further includes a transparent conductive layer TCL′. For instance, the transparent conductive layer TCL′ may include ITO, IZO or other suitable transparent conductive material(s). The array substrate structure AS′ of the display panel 100′ includes the first substrate 110, the circuit component layer 120, the conductive layer SCL1, the transparent semiconductor layer TSM, the conductive layer SCL2 and the transparent conductive layer TCL′. The transparent conductive layer TCL′ is electrically connected to the drain DE of the switching component SW through the through hole TH passing through the insulating layer IN3 and the insulating layer IN2, so as to make the transparent conductive layer TCL′ serve as the pixel electrode and receive the gray level signal, thereby adjusting the status of the display medium layer 140, but not limited thereto. The transparent conductive layer TCL′ is disposed in the reflective region RA and the light-transmitting region TA of the display region SPa of the pixel unit SP′. In the reflective region RA, the first electrode E1 of the power generating structure 130 is disposed on and electrically connected to the transparent conductive layer TCL′, such that the first electrode E1 serves as not only the electrode of the power generating structure 130 but also the pixel electrode receiving the gray level signal. In the light-transmitting region TA, light BL generated by the backlight module passes through the transparent conductive layer TCL′ and is seen by the user UR, such that the user UR sees the display image. The remaining parts of this variant embodiment could be referred to the first embodiment, and these contents will not be redundantly described. In this variant embodiment, the display panel 100′ may be a transflective liquid crystal display panel, but not limited thereto.

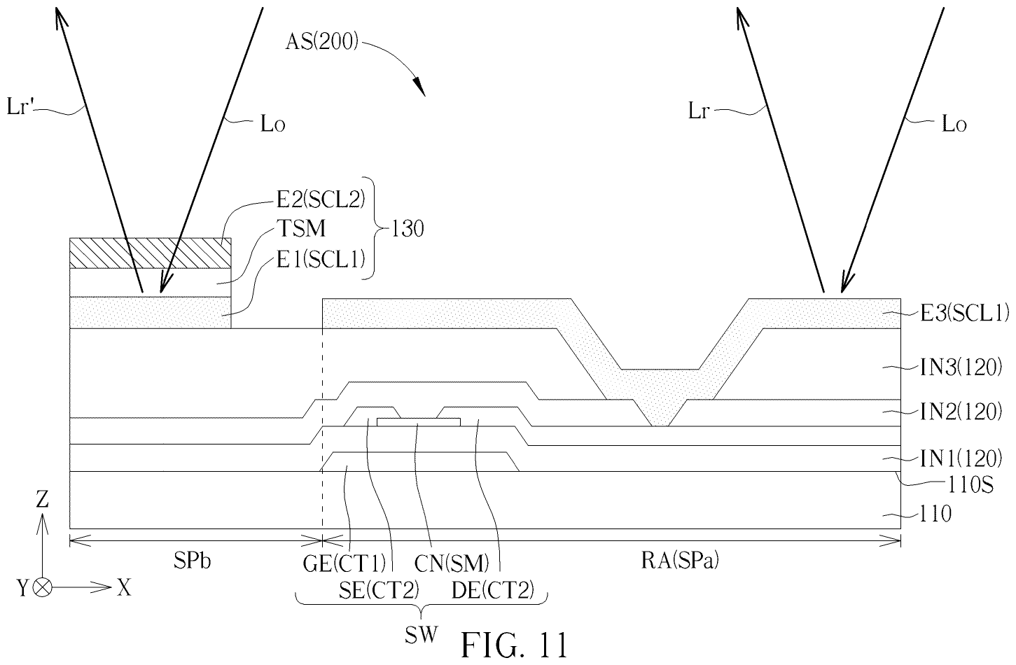

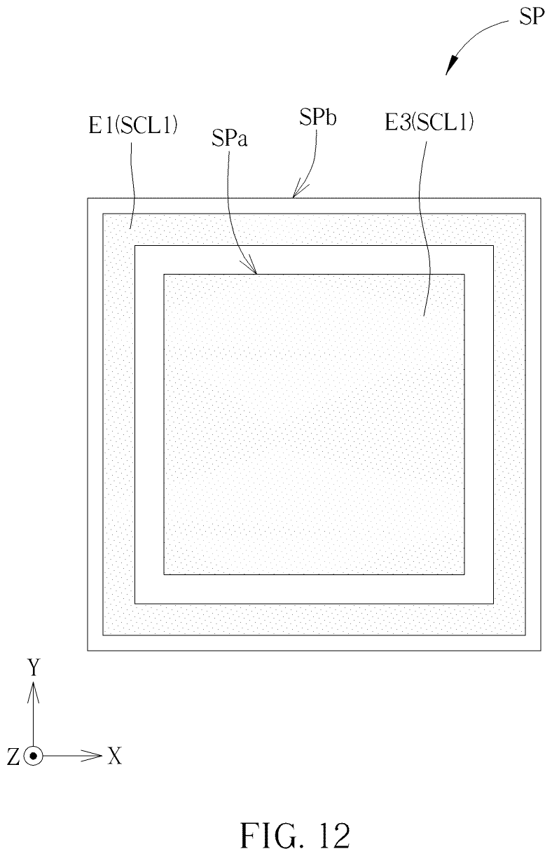

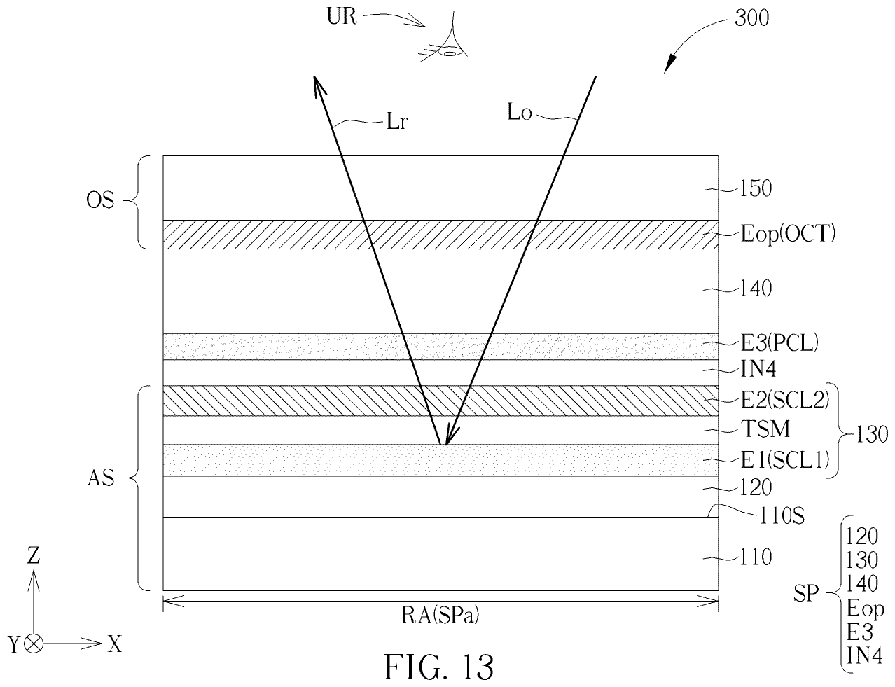

Referring to FIG. 10 to FIG. 12, FIG. 10 is a schematic diagram of a cross-sectional view illustrating a display panel according to a second embodiment of the present invention, FIG. 11 is a schematic diagram of a cross-sectional view illustrating a pixel unit of the display panel according to the second embodiment of the present invention, and FIG. 12 is a schematic diagram of a top view illustrating a conductive layer in the pixel unit of the display panel according to the second embodiment of the present invention. As shown in FIG. 10 to FIG. 12, a difference between this embodiment and the first embodiment is that the conductive layer SCL1 of the display panel 200 of this embodiment further includes a third electrode E3 (i.e., the conductive layer SCL1 includes the first electrode E1 of the power generating structure 130 and the third electrode E3), and the power generating structure 130 is disposed in a peripheral region SPb of the pixel unit SP, wherein the third electrode E3 is disposed in the reflective region RA of the display region SPa of the pixel unit SP, the first electrode E1 of the power generating structure 130 and the third electrode E3 are separated from each other and not electrically connected to each other (i.e., they are electrically insulated from each other), and the switching component SW (e.g., the drain DE) is electrically connected to the third electrode E3 and not electrically connected to the first electrode E1 (i.e., the switching component SW is electrically insulated from the first electrode E1). Therefore, the third electrode E3 is disposed in the pixel unit SP, serves as the pixel electrode and receives the gray level signal, thereby adjusting the status of the display medium layer 140. The first electrode E1 is configured to transmit the photocurrent generated by the power generating structure 130. The conductive layer SCL1 may be a single-layer structure including a metal reflective layer or a multi-layer structure including a metal reflective layer, wherein the metal reflective layer is configured to reflect the external light Lo. Therefore, the first electrode E1 of the power generating structure 130 and the third electrode E3 individually include the metal reflective layer (e.g., the metal reflective layer RL shown in FIG. 3). The third electrode E3 not only serves as the pixel electrode to adjust the status of the display medium layer 140, but also reflects the external light Lo to form the reflected light Lr, and the reflected light Lr is seen by the user UR, so as to make the user UR see the display image. The first electrode E1 of the power generating structure 130 reflects the external light Lo to form the reflected light Lr′, so as to make the transparent semiconductor layer TSM perform the photoelectric conversion again.

In this embodiment, in order to prevent the user UR from seeing a bad displaying region which is corresponding to the power generating structure 130 and caused by the electrically signal of the first electrode E1 and/or the electrically signal of the second electrode E2 (i.e., this electrically signal affects the status of a part of the display medium layer 140 corresponding to the power generating structure 130), the light shielding layer BM of the opposite substrate structure OS may be disposed in the peripheral region SPb of the pixel unit SP, and the light shielding layer BM overlaps the power generating structure 130 in the direction Z (the normal direction of the first substrate 110). Thus, the display quality of the display image is enhanced. Note that, although the light shielding layer BM overlaps the power generating structure 130 in the direction Z, since a part of the external light Lo obliquely enters the display panel 200, the power generating structure 130 is still irradiated by the external light Lo to generate the photocurrent.

According to above, the third electrode E3 of this embodiment serves as a reflecting structure configured to reflect the external light Lo to make the display panel 200 display an image. In some embodiments, the third electrode E3 may occupy most of the area in the pixel unit SP (e.g., a ratio of an area of the third electrode E3 to an area of the pixel unit SP may be greater than or equal to 0.5 and less than or equal to 1), so as to enhance the reflecting effect of the third electrode E3 and the brightness of the display panel 200.

As shown in FIG. 10 to FIG. 12, in the conductive layer SCL1, the first electrode E1 of the power generating structure 130 and the third electrode E3 may be disposed in the same pixel unit SP, and the dispositions of the third electrode E3 and the first electrode E1 may be designed based on requirement(s). For instance, in FIG. 12, the first electrode E1 is disposed around the third electrode E3, such that the power generating structure 130 is disposed around the third electrode E3 (e.g., the power generating structure 130 surrounds the third electrode E3), but not limited thereto. For instance, as shown in FIG. 10 to FIG. 12, the pixel unit SP may have the display region SPa and the peripheral region SPb disposed around the display region SPa, the third electrode E3 may be disposed in the display region SPa, and the power generating structure 130 may be disposed in the peripheral region SPb, wherein the display region SPa does not overlap the light shielding layer BM in the direction Z, and the peripheral region SPb overlaps the light shielding layer BM in the direction Z. For instance, in the top view, the area of the third electrode E3 may be greater than the area of the power generating structure 130, so as to enhance the reflecting effect of the third electrode E3 and the brightness of the display panel 200.

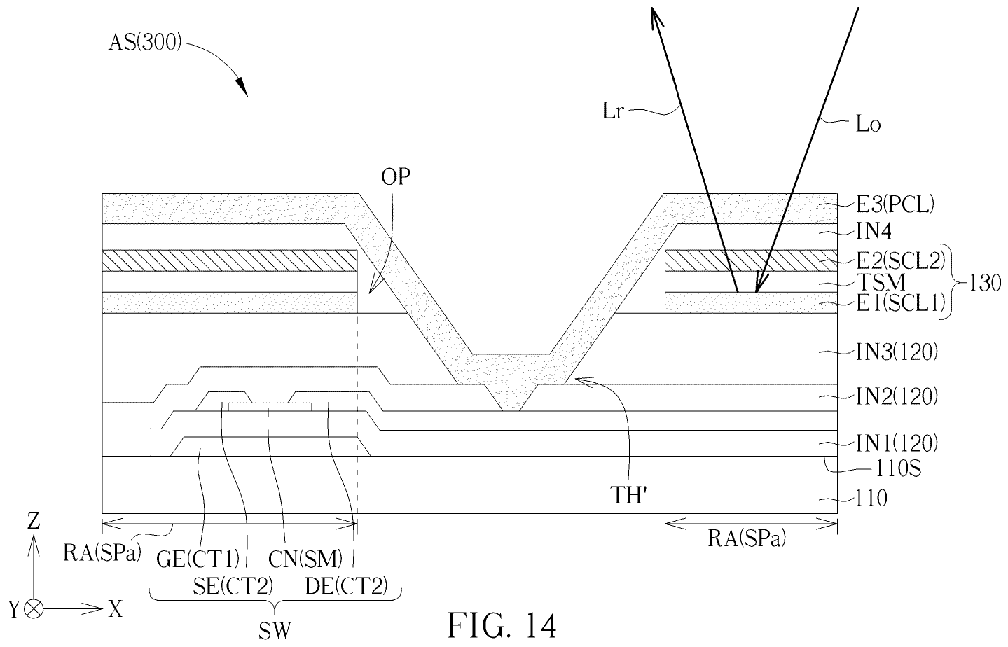

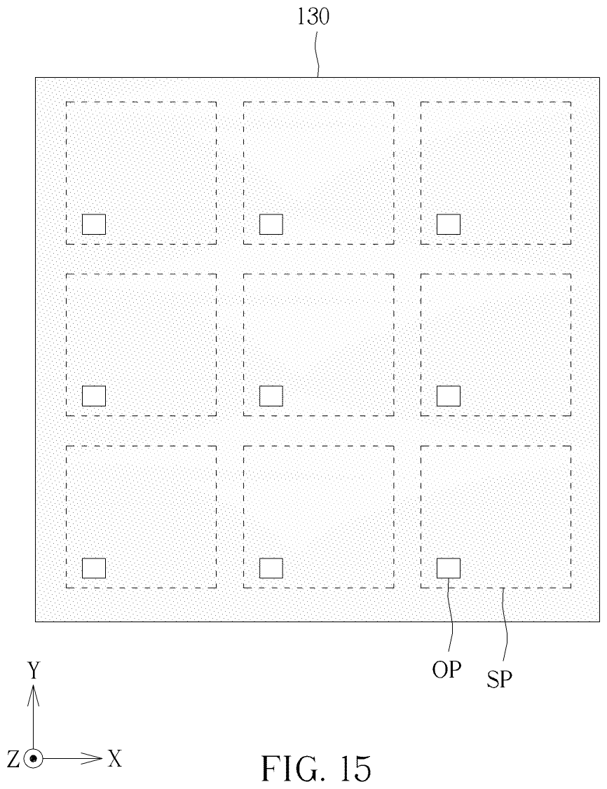

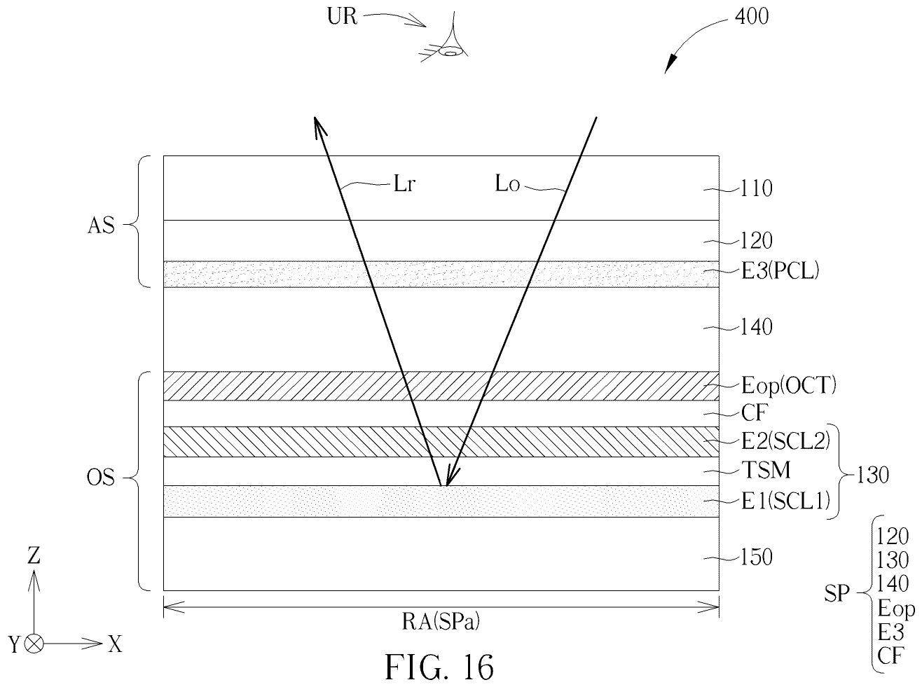

Referring to FIG. 13 to FIG. 15, FIG. 13 is a schematic diagram of a cross-sectional view illustrating a display panel according to a third embodiment of the present invention, FIG. 14 is a schematic diagram of a cross-sectional view illustrating a pixel unit of the display panel according to the third embodiment of the present invention, and FIG. 15 is a schematic diagram of a top view illustrating power generating structures in the pixel units of the display panel according to the third embodiment of the present invention. As shown in FIG. 13 to FIG. 15, a difference between this embodiment and the first embodiment is that the display panel 300 of this embodiment further includes a transparent conductive layer PCL and an insulating layer IN4, wherein the insulating layer IN4 is disposed between the power generating structure 130 and the transparent conductive layer PCL, and the transparent conductive layer PCL is disposed between the insulating layer IN4 and the display medium layer 140 (i.e., the transparent conductive layer PCL is disposed between the power generating structure 130 and the display medium layer 140). The transparent conductive layer PCL includes transparent conductive material (e.g., ITO, IZO, etc.), and the insulating layer IN4 includes a light-transmitting insulating material, such that the external light Lo and the reflected light Lr pass through the transparent conductive layer PCL and the insulating layer IN4. Note that the transparent conductive layer PCL and the insulating layer IN4 belong to the array substrate structure AS.

In FIG. 13 and FIG. 14, the transparent conductive layer PCL may include a third electrode E3, wherein the third electrode E3 and the power generating structure 130 are separated from each other and not electrically connected to each other (i.e., they are electrically insulated from each other), and the switching component SW (e.g., the drain DE) is electrically connected to the third electrode E3 and not electrically connected to the first electrode E1 (i.e., the switching component SW is electrically insulated from the first electrode E1). Thus, the third electrode E3 is disposed in the pixel unit SP, serves as the pixel electrode and receives the gray level signal, thereby adjusting the status of the display medium layer 140. The first electrode E1 is configured to transmit the photocurrent generated by the power generating structure 130.

As shown in FIG. 13 and FIG. 14, the disposition of the third electrode E3 of the transparent conductive layer PCL and the disposition of the power generating structure 130 may be designed based on requirement(s). For instance, in FIG. 13 and FIG. 14, the third electrode E3 and the power generating structure 130 may be disposed in the same pixel unit SP, and the third electrode E3 may overlap the power generating structure 130 in the direction Z, but not limited thereto. The through hole TH′ may pass through insulating layer IN4, the insulating layer IN3 and the insulating layer IN2, and the third electrode E3 may be electrically connected to the drain DE of the switching component SW through the through hole TH′. The first electrode E1 of the power generating structure 130 includes a metal reflective layer (e.g., the metal reflective layer RL shown in FIG. 3). Therefore, the first electrode E1 of the power generating structure 130 not only serves as the electrode of the power generating structure 130, but also reflects the external light Lo to form the reflected light Lr for making the transparent semiconductor layer TSM perform the photoelectric conversion again and making the user UR see the reflected light Lr (also see the display image). The second electrode E2 of the power generating structure 130 is a light-transmitting electrode and includes a transparent conductive layer. Thus, the external light Lo passes through the transparent conductive layer PCL, the insulating layer IN4 and the second electrode E2 to enter the transparent semiconductor layer TSM, and the reflected light Lr passes through the second electrode E2, the insulating layer IN4, the transparent conductive layer PCL, the display medium layer 140 and the opposite substrate structure OS, so as to be seen by the user UR.

As shown in FIG. 14 and FIG. 15, the power generating structures 130 of the pixel units SP may be coupled to each other, so as to increase the total area of the power generating structures 130. For instance, the first electrodes E1 (i.e., the conductive layer SCL1) of the power generating structures 130 of the pixel units SP may be coupled to each other, the transparent semiconductor layers TSM of the power generating structures 130 of the pixel units SP may be coupled to each other, and/or the second electrodes E2 (i.e., the conductive layer SCL2) of the power generating structures 130 of the pixel units SP may be coupled to each other, but not limited thereto. The power generating structure 130 may have an opening OP in the pixel unit SP, and the opening OP may overlap the through hole TH′ in the direction Z.

As shown in FIG. 13 and FIG. 14, since the third electrode E3 receiving the gray level signal is not electrically connected to the power generating structure 130, and the third electrode E3 is disposed between the power generating structure 130 and the display medium layer 140 in the direction Z, the electrical signals of the first electrode E1 and the second electrode E2 of the power generating structure 130 do not affect the status of the display medium layer 140, thereby enhancing the display quality of the display panel 300.

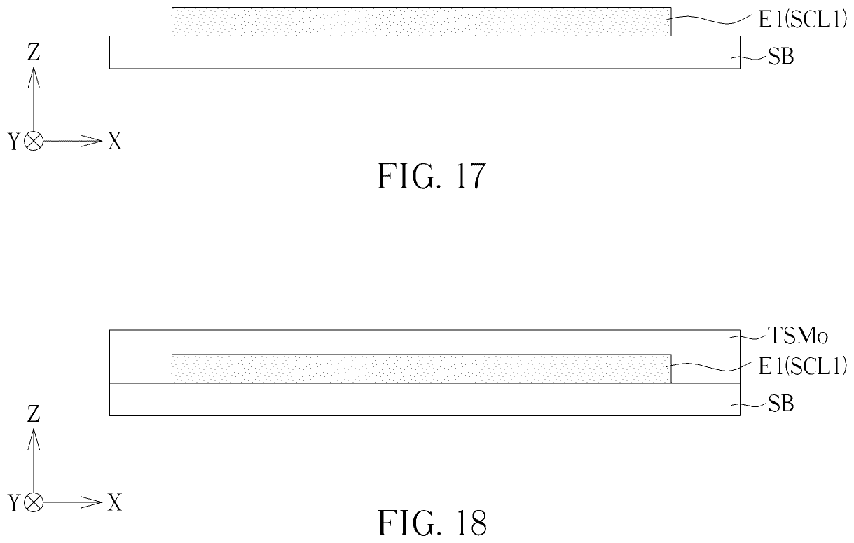

Referring to FIG. 16, FIG. 16 is a schematic diagram of a cross-sectional view illustrating a pixel unit of a display panel according to a fourth embodiment of the present invention. As shown in FIG. 16, a difference between this embodiment and the first embodiment is the position of the power generating structure 130 of the display panel 400 of this embodiment. As shown in FIG. 16, the power generating structure 130 may be disposed between the second substrate 150 and the display medium layer 140, such that the conductive layer SCL1, the transparent semiconductor layer TSM and the conductive layer SCL2 may be disposed between the second substrate 150 and the display medium layer 140. The first electrode E1 of the power generating structure 130 may be disposed between the second substrate 150 and the transparent semiconductor layer TSM, and the second electrode E2 of the power generating structure 130 may be between the transparent semiconductor layer TSM and the display medium layer 140. In FIG. 16, the power generating structure 130 (i.e., the conductive layer SCL1, the transparent semiconductor layer TSM and the conductive layer SCL2) may be disposed between the conductive layer OCT and the second substrate 150. Accordingly, the opposite substrate structure OS may include the second substrate 150, the conductive layer SCL1, the transparent semiconductor layer TSM, the conductive layer SCL2 and the conductive layer OCT.

In FIG. 16, the common electrode Eop of the conductive layer OCT and the power generating structure 130 may be separated from each other and not electrically connected to each other (i.e., they are electrically insulated from each other). Therefore, an insulating material may exist between the common electrode Eop and the power generating structure 130. For instance, as shown in FIG. 16, when the display panel 400 is a color display panel, the color conversion layer CF may be disposed between the common electrode Eop and the power generating structure 130 and disposed between the power generating structure 130 and the display medium layer 140 (i.e., the color conversion layer CF may be included in the opposite substrate structure OS), so as to separate the common electrode Eop and the power generating structure 130 and convert the color of the light. For instance (not shown in figures), if the display panel 400 is a monochrome display panel, the insulating layer may be disposed between the common electrode Eop and the power generating structure 130 (this insulating layer may be included in the opposite substrate structure OS).

In addition, the display panel 400 may further include a transparent conductive layer PCL having the third electrode E3, and the transparent conductive layer PCL may be disposed between the circuit component layer 120 and the display medium layer 140. The transparent conductive layer PCL may include transparent conductive material(s) (e.g., ITO, IZO, etc.), so as to make the external light Lo and the reflected light Lr pass through the transparent conductive layer PCL. In this embodiment, the switching component SW (e.g., the drain DE) may be electrically connected to the third electrode E3 of the transparent conductive layer PCL, and therefore, the third electrode E3 may serve as the pixel electrode and receive the gray level signal, thereby adjusting the status of the display medium layer 140. Note that the array substrate structure AS may include the first substrate 110, the circuit component layer 120 and the transparent conductive layer PCL.

As shown in FIG. 16, the external light Lo of this embodiment enters the display panel 400 from a side of the first substrate 110 opposite to the display medium layer 140. Thus, the external light Lo passes through the array substrate structure AS, the display medium layer 140, the conductive layer OCT, the color conversion layer CF, the conductive layer SCL2 and the transparent semiconductor layer TSM (the transparent semiconductor layer TSM performs the photoelectric conversion on a part of the external light Lo) in sequence. Then, the reflected light Lr reflected by the conductive layer SCL1 passes through the transparent semiconductor layer TSM (the transparent semiconductor layer TSM performs the photoelectric conversion on a part of the reflected light Lr), the conductive layer SCL2, the color conversion layer CF, the conductive layer OCT, the display medium layer 140 and the array substrate structure AS in sequence. Finally, the reflected light Lr is emitted from the display panel 400 for displaying. In this embodiment, as shown in FIG. 16, since the external light Lo and the reflected light Lr pass through the first substrate 110, the first substrate 110 is a light-transmitting substrate.

In the second embodiment, the third embodiment and the fourth embodiment, the transparent semiconductor layer TSM of the power generating structure 130 may be the aforementioned visible-light-absorbing transparent semiconductor layer or the aforementioned near-infrared-light-absorbing transparent semiconductor layer. The visible-light-absorbing transparent semiconductor layer and the near-infrared-light-absorbing transparent semiconductor layer could be referred to the first embodiment, and these contents will not be redundantly described.

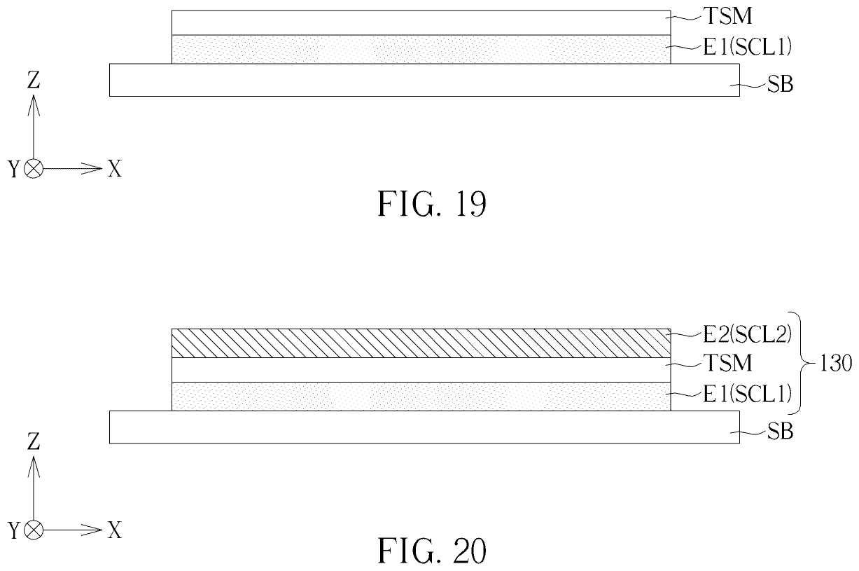

Referring to FIG. 17 to FIG. 20, FIG. 17 to FIG. 20 are schematic diagrams illustrating structures at different stages of a manufacturing method of a display panel according to an embodiment of the present invention, wherein FIG. 17 to FIG. 20 only show the formation of the power generating structure 130. The manufacturing method of the present invention is not limited to the following and the drawings. In some embodiments, any other suitable step may be added before or after one of the existing steps of the manufacturing method, and/or some steps may be performed simultaneously or separately.

In the following manufacturing method, the forming process of the layer and/or the structure may include an atomic layer deposition (ALD), a chemical vapor deposition (CVD), a physical vapor deposition (PVD), a coating process, any other suitable process or a combination thereof. The patterning process may include such as a photolithography, an etching process, any other suitable process or a combination thereof, wherein the etching process may be a wet etching process, a dry etching process, any other suitable etching process or combination thereof.

As shown in FIG. 17, the conductive layer SCL1 is formed on a substrate SB, wherein the substrate SB may include the aforementioned first substrate 110 or the aforementioned second substrate 150. For instance, the substrate SB may include the first substrate 110 and the circuit component layer 120 disposed on the first substrate 110 (e.g., the structure could be referred to the first embodiment, the second embodiment or the third embodiment), or the substrate SB may include the second substrate 150 (e.g., the structure could be referred to the fourth embodiment), but not limited thereto. In this step, a forming process of a first conductive material layer is performed to make the first conductive material layer be formed on the substrate SB. Then, a patterning process is performed on the first conductive material layer, so as to complete the formation of the conductive layer SCL1 having the first electrode E1. For instance, in the second embodiment, after forming the first conductive material layer on the circuit component layer 120, a patterning process is performed on the first conductive material layer to form the conductive layer SCL1, wherein the conductive layer SCL1 includes the first electrode E1 and the third electrode E3 (i.e., the patterning process is performed on the first conductive material layer to form the first electrode E1 and the third electrode E3).

As shown in FIG. 18 and FIG. 19, the transparent semiconductor layer TSM is formed on the conductive layer SCL1. For instance, in this step, a forming process of a transparent semiconductor material layer TSMo is performed to make the transparent semiconductor material layer TSMo be formed on the conductive layer SCL1 (as shown in FIG. 18), and then, a patterning process is performed on the transparent semiconductor material layer TSMo to complete the formation of the transparent semiconductor layer TSM (as shown in FIG. 19). For instance, the transparent semiconductor material layer TSMo may be formed by a coating process, but not limited thereto.

As shown in FIG. 20, the conductive layer SCL2 is formed on the transparent semiconductor layer TSM. For instance, in this step, a forming process of a second conductive material layer is performed to make the second conductive material layer be formed on the transparent semiconductor layer TSM, and then, a patterning process is performed on the second conductive material layer to complete the formation of the conductive layer SCL2 having the second electrode E2. Accordingly, the power generating structure 130 having the first electrode E1, the transparent semiconductor layer TSM and the second electrode E2 is formed by the aforementioned steps.

In summary, in the present invention, since the display panel displays an image by reflecting the external light, and the display panel has the power generating structure capable of absorbing the external light to generate electricity, the display panel has the display function and the power-generating function simultaneously.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display panel, comprising:
a substrate; and
a plurality of pixel units disposed on the substrate, wherein each of the pixel units comprises a power generating structure, and the power generating structure comprises:
a first electrode, wherein the first electrode comprises a metal reflective layer;
a second electrode disposed on the first electrode, wherein the second electrode comprises a transparent conductive layer; and
a transparent semiconductor layer disposed between the first electrode and the second electrode, wherein the transparent semiconductor layer is electrically connected to the first electrode and the second electrode.

2. The display panel according to claim 1, wherein each of the pixel units has a display region, each of the display regions has a reflective region, each of the power generating structures is situated in the reflective region of the display region of corresponding one of the pixel units, the reflective regions of the pixel units reflect a part of an external light to form an image, and the transparent semiconductor layer is configured to convert another part of the external light into a photocurrent.

3. The display panel according to claim 2, wherein in each of the power generating structures, the first electrode or the second electrode serves as a pixel electrode during a display period of the display panel.

4. The display panel according to claim 2,
wherein the pixel units are disposed on a surface of the substrate, and each of the pixel units further comprises a pixel electrode, an insulating layer and a display medium layer;
wherein in each of the pixel units, the pixel electrode is disposed between the display medium layer and the power generating structure in a direction perpendicular to the surface of the substrate, the insulating layer is disposed between the power generating structure and the pixel electrode in the direction perpendicular to the surface of the substrate, and the pixel electrode and the power generating structure are electrically insulated from each other.

5. The display panel according to claim 1, wherein each of the pixel units has a display region and a peripheral region, each of the display regions has a reflective region, and the power generating structures are situated in the peripheral regions.

6. The display panel according to claim 5,
wherein each of the pixel units further comprises a pixel electrode, and each of the pixel electrodes is situated in the reflective region of the display region of corresponding one of the pixel units;
wherein in each of the pixel units, the first electrode and the pixel electrode belong to a same conductive layer, and the first electrode and the pixel electrode are electrically insulated from each other.

7. The display panel according to claim 1, further comprising another substrate;
wherein each of the pixel units further comprises a circuit component layer, a pixel electrode and a display medium layer;
wherein in each of the pixel units, the circuit component layer comprises a thin film transistor, the pixel electrode is electrically connected to the thin film transistor, the circuit component layer and the pixel electrode are disposed between the another substrate and the display medium layer, and the power generating structure is disposed between the substrate and the display medium layer.

8. The display panel according to claim 1, wherein the display panel is a reflective display panel or a transflective display panel.

9. The display panel according to claim 1, wherein the transparent semiconductor layer has an absorption peak in a visible light band.

10. The display panel according to claim 1, wherein the transparent semiconductor layer has an absorption peak in a wavelength band greater than 650 nm.

11. A manufacturing method of a display panel, the display panel comprising a plurality of pixel units, each of the pixel units comprising a power generating structure, the manufacturing method comprising following steps:
forming a first electrode of the power generating structure on a substrate, wherein the first electrode comprises a metal reflective layer;
forming a transparent semiconductor layer of the power generating structure on the first electrode; and
forming a second electrode of the power generating structure on the transparent semiconductor layer, wherein the second electrode comprises a transparent conductive layer.

12. The manufacturing method according to claim 11, further comprising a following step:
forming a circuit component layer on the substrate, wherein the circuit component layer comprises a thin film transistor, and the circuit component layer is formed before the first electrode of the power generating structure is formed;
wherein the first electrode of the power generating structure is disposed on the circuit component layer after the first electrode is formed.

13. The manufacturing method according to claim 12, further comprising a following step:
forming a pixel electrode on the circuit component layer, wherein the step of forming the first electrode of the power generating structure and the step of forming the pixel electrode comprise:
forming a conductive material layer on the circuit component layer; and
patterning the conductive material layer to form the first electrode and the pixel electrode.
